(19) United States
(12) Patent Application Publication
(10) Pub. No.: US 2005/0251415 A1
(43) Pub. Date: Nov. 10, 2005

(54) System and method for consultation on dermatological disorders

(76) Inventor: Hon S. Pak, San Antonio, TX (US)

Correspondence Address: Alan R. Thicle;Strasburger & Price, LLP, Suite 4300, 901 Main St., Dallas, TX, 75202, US

(21) Appl. No.: 10/841,140

(22) Filed: May 7, 2004

(51) Int. Cl. G06F 17/60

(52) U.S. Cl. 705/2

(57) ABSTRACT

The system and method of the present invention enables obtaining a consult report from a specialist located at a remote location. The disclosed invention is described in terms of an Internet-enabled communication system facilitating sending patient information to a consulting teledermatologist. The response from the consulting teledermatologist is a completed consult report. Also provided are tracking and notice systems.

The disclosed system and method provides specialty dermatological consultation for primary-care physicians or healthcare professionals recognizing a dermatological disorder. The disclosed system and method uses Internet-based communication; more particularly, the disclosed system and method allows for the simplified acquisition, transfer, and tracking of both information and multiple digital images to an expert in dermatological disorders via a high-speed Web server with a scalable database.

### BACKGROUND

A significant shortage and maldistribution of dermatologists exists in the US. This problem is particularly acute in rural or remote locations. It is in these rural or remote locations that complex or unusual dermatological maladies often arise because of prolonged exposure to manufactured agricultural or industrial chemicals or contact with natural chemicals produced by plants or animals. This shortage and maldistribution of dermatologists in rural or remote locations has caused significant problems for those patients having dermatological disorders and needing a referral to a physician trained in dermatology for proper diagnosis, recommendation of a treatment regimen, and a plan for follow-up.

Compounding the problem of the shortage and maldistribution of dermatologists is the continued increase in the cost of obtaining specialized medical advice. Specifically, without some way of communicating a dermatological problem to a trained specialist, patients suffering from complex or unusual dermatological disorders simply may not be able to afford the expense of first finding and then traveling to the office of an expert in recognizing and treating complex unusual skin problems.

The continued growth in the use of telemedicine has provided some relief to those seeking diagnosis and treatment of complex or unusual dermatological disorders; however, communication problems still remain in controlling access to information concerning the patient, and promptly communicating needed information about the patient's dermatological disorder, its diagnosis, treatment regimen, and follow-up plan.

One basic teledermatology system has been proposed in pending published U.S. Patent Application 2002/0016720 A1, filed Feb. 22, 2001.

However, a need still remains in the art for a simplified system and method to both track and facilitate secure and rapid consultation between a primary-care physician recognizing a dermatological disorder and a physician with expertise in diagnosing, recommending a treatment regimen, and creating a follow-up plan for dermatological disorders.

### SUMMARY

A system and method to both track and facilitate secure consultation between a primary-care physician recognizing a dermatological disorder and a physician having expertise in dermatological disorders is disclosed.

The system and method of the present invention is a Web-based application that is enabled by the use of high-speed Web servers with a scalable database. The disclosed invention allows for the submission and review of information concerning a dermatological disorder between a requesting primary-care physician and a consulting teledermatologist using a store-and-forward methodology. While the present invention is described in terms of facilitating a consultation with a dermatologist, those of ordinary skill in the art will understand that numerous other types of medical and non-medical consultations are enabled by the disclosed invention.

Users of the present invention typically include: a primary-care physician or healthcare professional that actually visits with the patient; a consult manager—typically co-located with the primary-care physician; the dermatologist identified for consultation; and those Internet communication specialists responsible for the operation of the disclosed system. The dermatologist identified for consultation may be located a long distance away from the primary-care physician. Dermatologists who provide consultation from remote locations are called consulting teledermatologists herein.

The users of the present invention; specifically, the primary-care physician, the consult manager, the consulting dermatologist, and the Internet communication specialists will log on to a secure Website to gain access to a Web-based system. Each user is registered and qualified by a site administrator.

Once a primary-care physician has been registered as being among those granted access to the disclosed system, the primary-care physician can then enter information into a patient information record using a standardized template constructed specifically to communicate information about the dermatological disorders of a patient. The primary-care physician has the option of uploading multiple digital photographic images of the patient's skin disorder, or the primary-care physician may defer sending photographic images until a later time. It is anticipated that the consult manager (who is usually co-located with the primary-care physician) or the primary-care physician him/herself will obtain digital photographic images of the skin disorder of the patient and then upload these digital photographic images into a request for a consult report once the primary-care physician has actually visited with the patient. Once the digital photographic images of the patient's skin disorder are uploaded and submitted to the consulting teledermatologist along with any written clinical information as a request for a consult, the consulting teledermatologist will be able to, first, render a diagnosis and, second, create a treatment recommendation and follow-up plan. Alternatively, the consulting teledermatologist may request additional information from the primary-care physician to improve his/her diagnosis, treatment regimen, and follow-up plan.

Once the clinical information and digital images have been received by the consulting teledermatologist and all questions have been answered, the consulting teledermatologist can then enter his/her diagnosis, treatment recommendations, and follow-up plan using another template designed to efficiently communicate all needed information. Once the request for a consult report is answered by a consulting teledermatologist, a notification e-mail is sent to the requesting primary-care physician. This notification includes a link to where the requesting physician will be able to locate the completed consult report.

All requests for a consult report trigger a tracking system that enables a user to determine how close the consult report is to completion. The tracking system produces a status designation that allows users to more effectively track and organize each individual request for a consult report request with the consulting teledermatologist. In addition the disclosed system provides notice of the completed consult report.

### BRIEF DESCRIPTION OF THE DRAWING FIGURES

A better understanding of the system and method for consultation on dermatological disorders of the present invention may be had by reference to the drawing figures wherein:

FIG. 1 is a schematic diagram of the information flow facilitated by the disclosed system and method;

FIG. 2 is a schematic diagram of the organization of the information flow to the consulting teledermatologist provided by the disclosed system and method;

FIG. 3 is a schematic diagram of the organization of the information flow from the consulting teledermatologist provided by the disclosed system and method;

FIG. 4 is a schematic diagram of the system which enables the communication flow of the disclosed system and method;

FIG. 5 is a schematic diagram of the screen made available to a patient whose dermatological disorder is the subject of information flowing through the disclosed system;

FIG. 6 is a schematic diagram of the screen provided to a requesting physician seeing the patient with the dermatological disorder;

FIG. 7 is a schematic diagram of the screen provided to a consulting teledermatologist providing the diagnosis and proposed treatment regimen and follow-up plan for dermatological disorder;

FIG. 8 is a schematic diagram of the screen provided to a consult manager assisting the requesting physician in obtaining information describing the patient's dermatological disorder; and

FIG. 9 is a schematic diagram of the screen provided to a system administrator overseeing the operation of the system and method of the present invention.

### DESCRIPTION OF THE EMBODIMENTS

General Description

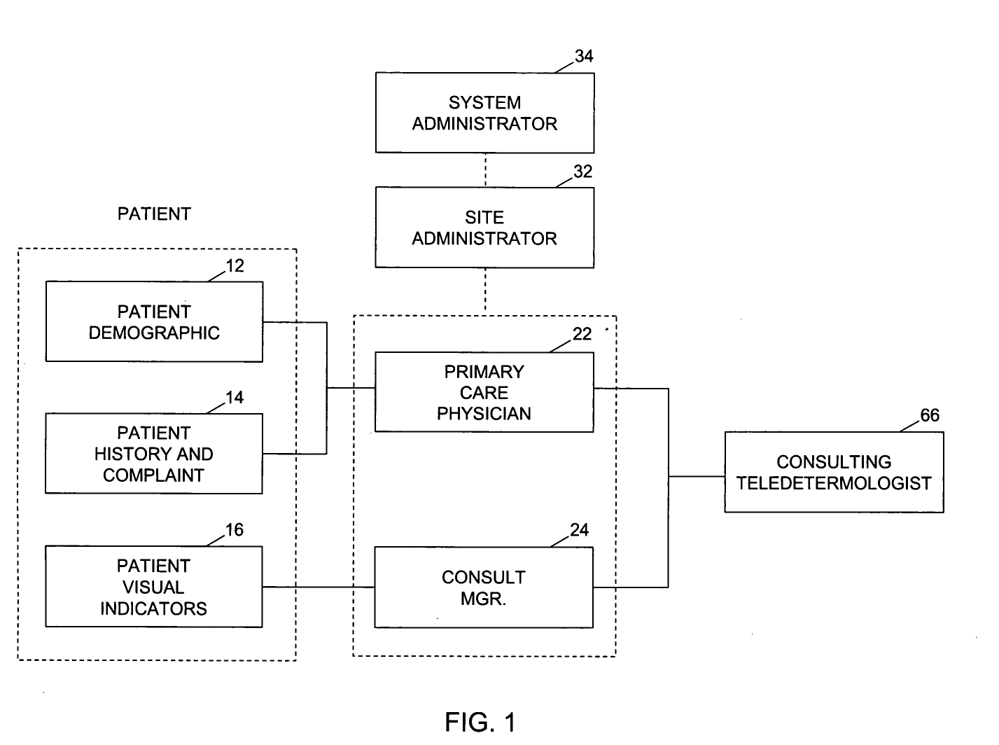

As may be seen in FIG. 1, a patient with a suspected dermatological disorder visits a primary-care physician 22 at an identified site. The primary-care physician or his/her staff gather identifying demographic information 12 about the patient. Information about the patient's medical history and complaint 14 is also gathered. If the patient's complaint includes visual indicators of the existence of a dermatological disorder such as lesions, rash, or redness, these visual indicators 16 may be photographed using a camera capable of producing a digital image. Once in digital format, the image may be transmitted electronically. Once all relevant information is gathered, the information about the patient and the dermatological disorder may then be sent to a consulting dermatologist 32 in the form of a request for consult report. When completed, the consult report rendered in response to a request for consult report will typically include a diagnosis, a recommendation of a treatment regime, and a follow-up plan.

As in a traditional medical consultation, the patient is the ultimate recipient of diagnosis, treatment regimen, and follow-up plan provided by the consult system enabled by the present invention.

As the disclosed system and method is currently practiced, the patient will have scheduled an appointment to see his/her primary-care physician 22 because of a skin problem. If a dermatologist is not readily available to see the patient, the system and method of the present invention provides an option for the primary-care physician 22. Specifically, the primary-care physician 22 will be able to transmit information about the skin problem affecting his/her patient to a consulting teledermatologist 32.

In an organization which includes one or more primary-care physicians 22, a central consult processing center will be located at the site. At the central consult processing center, the appropriateness of using the system and method of the present invention will be determined.

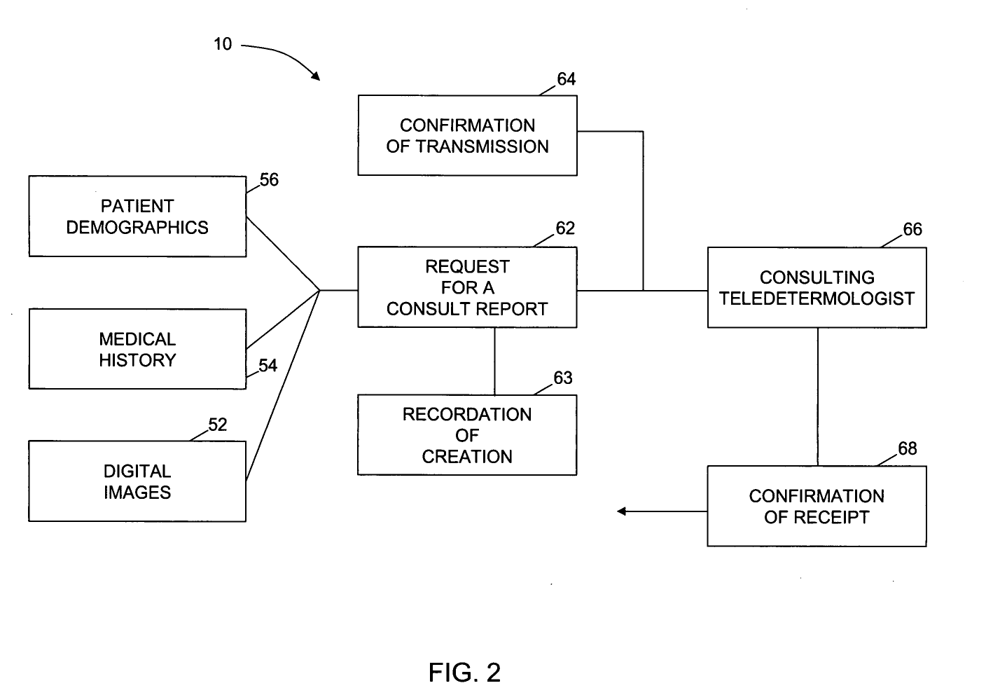

Once the primary-care physician 22 has determined that a consult with a consulting teledermatologist 66 is needed, the consult manager 24 will explain the consult process to the patient and gather the information needed. Further, the consult manager 24 will obtain the patient's consent for obtaining a digital photograph of the skin problem. Once the required consent has been obtained, the consult manager 24 will register the patient, then gather additional patient data, using a template to facilitate the recording of needed information. Then, using another template designed specifically for recording and identifying digital photographic images, the consult manager 24 will take the necessary photographic images with a digital camera to create a visual record of the dermatological disorder. As shown in FIG. 2, the digital photographic images 52 will be added to the selected patient demographic information 56 and the patient's medical history 54 to create a request for a consult report 62. The request for a consult report 62 initiates the communication envisioned in the disclosed system. For tracking purposes, the system 10 maintains a record 63 of the completion of the request for a consult report 62.

The consult manager 24 will be able to sign on to the disclosed Web-based communication system 10 using a unique ID/password. The patient's demographic information 56 and medical history 54, now in electronic form, along with the corresponding digital photographic images 52, will then be transmitted to a consulting teledermatologist 66 using the disclosed system 10.

The requesting physician 22 has the option of entering the patient's demographic 56 and medical 54 information by him/herself at the proper screen and then allowing the consult manager 24 to acquire and attach/submit the digital photographic images 52 at another screen or do it all him/herself. Once the request for a consult report 62 has been submitted, as shown in FIG. 2, a consulting teledermatologist 66 with an appropriate state license will then be able to view the request for a consult report 62, which should now include the patient's demographic information 56, the patient's medical history 54, and the digital photographic images 56 of the patient's dermatological disorder. The disclosed system 10 will then record when the request for a consult report 62 has been conveyed 64 to the consulting teledermatologist 66. The system 10 will also confirm 68 when the consulting teledermatologist 66 has received the request 62. The consulting teledermatologist 66 will then render a diagnosis and, if warranted, a treatment regimen and follow-up plan. The diagnosis and treatment regimen will be entered into the system by the consulting teledermatologist 66 and returned in the form of a consult report back to the referring physician 22. The system will record when a complete answer has been supplied to the request for a consult report.

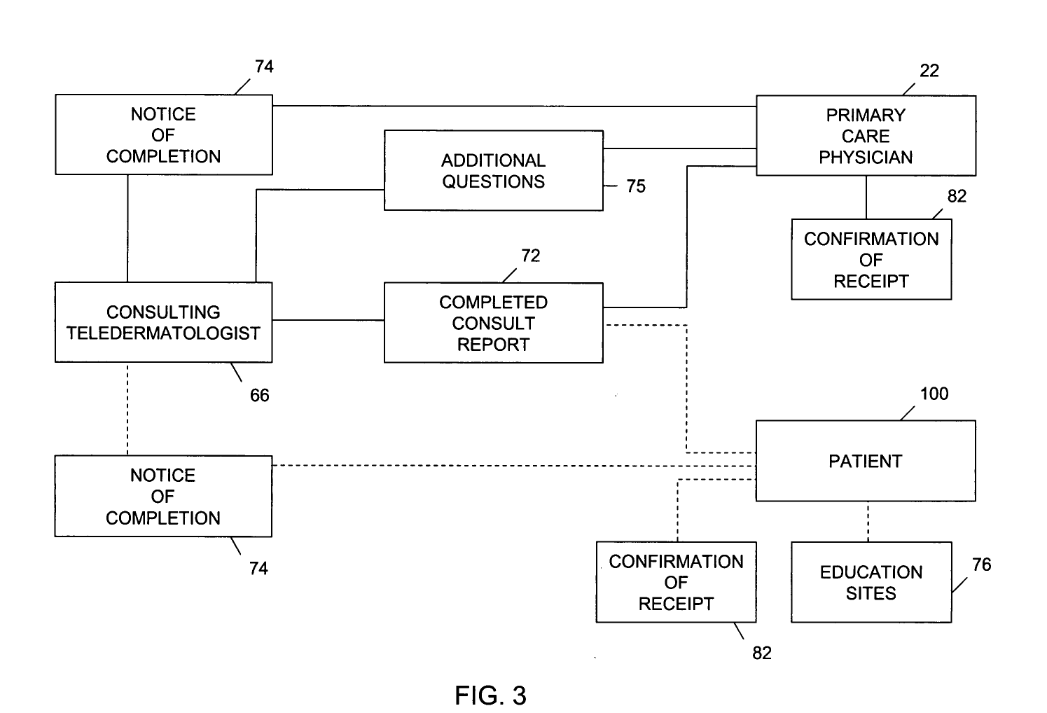

As shown in FIG. 3, once the diagnosis, treatment regimen, and follow-up plan embodied in a completed consult report 72 are entered into the system 10 by the consulting teledermatologist 66, the system 10 will generate a message 74 to the site consult manager 24 and the requesting physician 22 by e-mail. The e-mail message includes a link to the completed consult report 72. This e-mail message 74 provides notification that the request for a consult report 62 has been answered and the consult report 72 has been completed. Both the consult manager 24 and the requesting physician 22 can log on to the system 10 using the link provided in an e-mail message to view the diagnosis, the recommendations for a treatment regimen, and the follow-up plan contained in the completed consult report 72. The dashed lines in FIG. 3 indicate that the option is provided of notifying the patient 100 directly that the consult report 72 has been competed. After the patient 100 has been notified that the consult report 72 has been completed, the consult manager 24 or the requesting physician 22 can then document that the patient has been notified. The notification of the patient that the consult report 72 has been completed ends the consult process. Until the requesting physician 22 or the consult manager 24 notifies the patient 100 that the consult report 72 has been completed and the patient has received the diagnosis, the treatment regimen, and the follow-up plan, the system will carry the patient's status as being active.

When the patient 100 is provided the option of receiving the consult report, the patient 100 must personally log on to the system 10 using a designated ID/password to gain access to his/her completed consult report 72. From the completed patient consult report 72, the patient will be able to have the link to patient education sites 76 to learn more about the diagnosis of his/her skin condition, the recommended treatment regimen, and the follow-up plan.

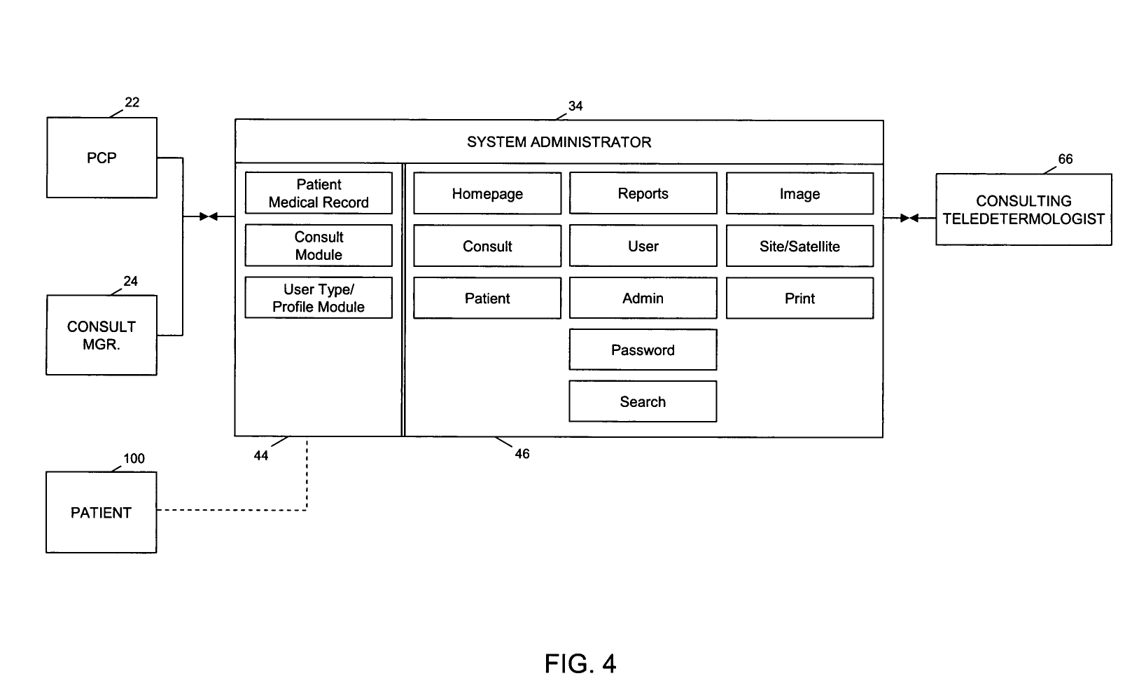

The Internet-based communication system of the present invention includes software which facilitates communication between work stations and computer servers. This software is explained below and appears in FIG. 4.

Architectural Design

Functional Modules 44
1. Patient Medical Record Module
2. Consult Module
3. User Type Profile Module

Application Logic/Rules Modules 46

Within the description of the User Type Profile Module in the functional modules 44 are more detailed descriptions of the screens made available to the authorized users, including:
Patients
Requesting Physicians
Consulting Teledermatologists
Consult Managers
Site Administrators
Others

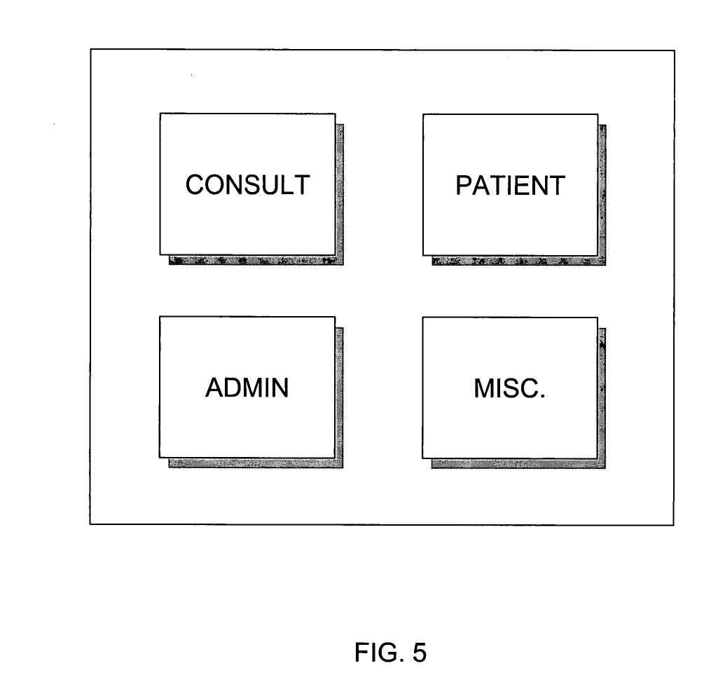

On the various screens provided to the foregoing users are a group of buttons, as described in FIGS. 5, 6, 7, 8 and 9, which enable a variety of system capabilities. These system capabilities are tied to the array of Application Logic/Rules Modules 46.

Architectural Design

The page that first appears after a requesting physician 22, consult manager 24, or a consulting teledermatologist 66 logs on to the system 10 is a user-specific page that organizes and lists only those requests for a consult report 62 which relate only to the authorized user logged on to the system 10. Short cuts are linked to each request for a consult report 62 shown on the homepage for the logged-on user. These shortcuts allow the most common tasks to be only a minimal number of steps away. Each of the records generically described below have a uniform layout of menus. These menus allow users to navigate through the record for each patient to provide requested information easily.

The electronic patient record is a structured, open database that contains patient identification information, including the patient's name, gender, age, etc., along with a basic medical history that is specific to dermatological maladies (e.g., history of melanoma, family history of melanoma, history of skin cancer, medication, etc.).

The consult record is a structured, open database that stores information relevant for a given patient. During the creation of a new request for a consult report 62, a new consult record may be created for a new patient, or an existing consult record may be selected. Each consult record allows for recording up to five separate patient complaints. The electronic patient record, described above, for a particular patient is intimately linked with the consult record for the same patient. Both the electronic patient record and the consult record are viewed together when any given consult record is viewed.

The consult status record provides a tracking system which indicates whether the request for a consult report 62 has been created 63, whether the request for a consult report 62 has been transmitted 64 to the consulting teledermatologist 66, whether the consulting teledermatologist 66 has received 68 the request for a consult report 62, whether the dermatologist has completed 74 the consult report 72 or has asked additional questions 75, and whether the completed consult report 72 has been received and viewed 82 by the requesting physician 22, and, if so designated, whether the completed consult report 72 has been reviewed by the patient 100.

Functional Modules

1. Patient Medical Record Module

a. Add/Edit Patient Section

The Add/Edit patient section of the Patient Medical Record Module allows users to add new patient information or to edit existing patient information. The patient information is separated into four main categories. Each category of patient information includes a set of questions to facilitate proper use of the system 10. The responses to the questions may be in free text data entry or in a predetermined format—which predetermined format can be selected by selecting a button appearing on the screen designed for each user. Certain patient information fields designated with an asterisk are mandatory. In this section, the user can navigate through the array of questions using the Tab key or using “next/back” buttons.

When a requesting physician 22 decides to use the disclosed system 10 for seeking consultation in treating a dermatological disorder of a new patient, the first step in the process is the creation of a new patient medical record. To begin the creation of a new patient medical record, the system 10 displays an empty record of patient demographic data 12. The empty record of patient demographic data 12 allows for rapidly gathering and converting gathered information into a succinct format.

Gathered Information: Age-34; gender-male; duration-3 years; chief complaint-rash on foot

Converted Format: Pt is a 34 year old male with a 3 year history of a foot rash.

b. Patient Record section

This section includes:
Demographics (name, age, gender, etc.)
Clinical History (patient medical history, patient treatment history, family history, allergies, etc.)
Insurance information
Medications and date started

When a request for a consult report 62 is being created for a patient 100 by a requesting physician 22 or by a consult manager 24—after the demographic information 12 has already been loaded into the system 10—the first step is to pull up the patient information 12. To pull up the patient information 12, the user is directed to the patient record section. The patient record section allows the user to search only for patients listed as being patients of physicians 22 in a particular organization. Alternatively, when the user is selecting a patient, the system 10 will allow the requesting physician 22 or the consult manager 24 to view a summary patient information page. With the summary patient information page on screen, the requesting physician 22 or the consult manager 24 may edit any patient information prior to creating a request for a consult report 62 to be sent to a consulting teledermatologist 66.

c. Links Section

This section includes:
Demographic information and insurance information structured so that it may be linked to a third-party billing system using an HL-7 or similar interface.
Demographic and basic clinical information designed in an open database structure to allow for optional future integration into an existing legacy system interface (customers' electronic patient record systems). Demographic and clinical information may be selected automatically using the HL-7 protocol, while still meeting the relevant HIPAA standards.
   2. Consult Module

The consult module captures, stores and displays the patient's clinical information in a logical fashion. The consult module is made up of several components or templates as described below. It is not unusual for a single patient to have multiple skin complaints. Using the disclosed system 10, multiple complaints about skin maladies may be submitted to the consulting teledermatologist 66 in one request for a consult report 62. This complaints-based request for a consult report 62 allows the consulting teledermatologist 66 to give independent answers to each patient complaint described in the request for a consult report 62. Each request for a consult report 62 will be linked to a requesting physician 22 using a drop-down list once the requesting physician 22 is registered as an authorized participant in the system 10.

a. Description Section

The description section of the consult module allows the requesting physician 22 or the consult manager 24 to provide a description of the patient's main skin complaint, its duration, the associated symptoms, any exacerbating factors, any ameliorating factors, etc. Unlike prior art systems, the most common choices about a patient's skin malady are displayed for the primary-care physician or healthcare professional in a pick-list (see Review of Symptoms list below) to accelerate the data entry process. Also included is an image of a human body. The human body image allows users to select the location of the skin malady on the patient's body with a mouse click. Alternatively, the requesting physician 22 or the consult manager 24 also has the option of providing a written description of the location of the skin malady.

The review of symptoms list described above is one example of a pick-list item. Other pick-list items may be added as needed as users gain experience with the disclosed system. The review of symptoms list includes common symptoms typically found in most dermatology patients. When the review of symptoms list is used, the requesting physician 22 or consult manager 24 may easily go through the Review of Symptoms list and select any pertinent systems pertaining to the patient's skin malady. Alternatively, the requesting physician 22 or the consult manager 24 may enter a more detailed description of the symptoms being experienced by the patient 100.

b. Preliminary Diagnosis Section

In the preliminary diagnosis section, the primary-care physician 22 or the consult manager 24 may either select (from a drop-down list) or manually enters what he/she believes to be a proper preliminary diagnosis of the skin malady, along with any questions relating to the skin malady.

c. Image Section

In the image section, the requesting physician 22 or the consult manager 24 has the option of attaching any digital photographic images 52 or submitting the request for a consult report 62 without any digital photographic images 52. Each screen for describing a patient complaint will produce a set of data (fields) along with the ability to upload one or more digital photographic image(s) 52 of the skin area affected. All digital photographic images 52 are linked to a specific patient complaint. If desired, each digital photographic image 52 will be DICOM compliant and watermarked to assure a trail of modifications. Multiple digital photographic images 52 will be linked as a group to each patient complaint. The digital images 52 may be entered by the requesting physician 22 or by the consult manager 24. It is anticipated that the consult manager 24 will see the patient 100 after the requesting physician 22 and will add digital photographic images 52 of the skin disorder after the patient has been seen by the requesting physician.

d. Addendum Section

In the addendum section, the requesting physician 22 or the consult manager 24 may attach more images and/or manually add text to the request for a consult report 62. The requesting physician 22 or the consult manager 24 can search for a request for a consult report 62 created by his/her organization using a patient's name, last initial, or SSN during a specified time period. The requesting physician 22 or the consult manager 24 can also flag any request for a consult report 62 and add additional comments. The flag function allows for an easy retrieval of a request for a consult report 62 at a later time.

e. View Section

The view section provides access to a summary of all the information relating to the request for a consult report 62 along with the patient's medical 14 and demographic 12 information. Clinical data from multiple distinct fields are converted into paragraph form. In paragraph form, the clinical data is presented in a format that allows rapid read/review of pertinent patient information without any extraneous information. A sample summary of information in paragraph form appears below. For example, if 34-year-old man is complaining of a pruritic rash that has been symptomatic for three years, the system would allow the requesting physician or healthcare professional to produce the following succinct description in paragraph form.

Patient is a 34-year-old male with a 3-year history of a pruritic rash.

f. Answer Consult Section

In the answer consult section, the consulting teledermatologist 66 is able to view a summary of the information gathered by the requesting physician 22 and the consult manager 24. This screen on which this summary of information appears can be slightly different than the screen used by a primary-care physician 22 or a consult manager 24. When answering a request for a consult report 62, the consulting teledermatologist 66 will be supplied with the needed patient demographic 12 and medical 14 information together with information about the dermatological malady. A digital photographic image window within the answer consult section shows thumbnail views of the images illustrating the patient's skin malady. The consulting teledermatologist 66 selects a thumbnail view to open up a larger view. The main window within the answer consult section allows the consulting teledermatologist 66 to render a diagnosis of the skin malady, make recommendations for treatment of the skin malady, and detail future follow-up instructions. A standard template format is provided to simplify this process for the consulting teledermatologist 66.

The response portion of the answer consult section used by a consulting teledermatologist 66 to enter a diagnosis, a treatment regimen, and a follow-up plan is customizable based on the needs of the requesting physician 22 or consult manager 24. The consulting teledermatologist 66 is aided by the use of buttons which provide links to routine descriptions that may be used to create text in a field. For example, the selected text will include some basic language describing a recommended course of action. If desired, the basic language describing a recommended course of action can be further edited manually. Furthermore, each recommendation for a course of action may include a pop-up reminder window that forces a follow-up entry. Lastly, the name of the point of contact, the phone number, and e-mail address are linked to the answer consult section so that the actual data is automatically pulled from the patient demographic data 12.

3. User Type/Profile Module

All users (including primary-care physicians 22, consult managers 24, consulting teledermatologists 66, and patients 100) must be registered as associated with a designated site. Only after a patient record has been added to the system by an authorized user can a request for a consult report 62 be generated. Typically, a consult manager 24 will register the other users.

Consult managers 24 are in turn registered in the system by a site administrator 32, as shown in FIG. 1. A single site administrator 32 may oversee the offices of a group of requesting physicians 22. The list of site administrators 32, along with the name of their organization, is added to the system by the system administrator 34. In addition to the registration by the consulting manager 24, all consulting teledermatologists 66 are registered by the system administrator 34 as a unique organization. The operation of the User Type/Profile Module will be explained by reference to the various screens included therein.

a. Patient Screen

The patient screen is used in the patient registration process. This screen provides for the entry of routine patient demographic information (age, gender, address, insurance, etc.) and basic relevant medical history (patient medical history to include prior skin cancer history, patient treatment history, family history, medications, pregnancy status, etc.). Patient registrations into the system 10 are typically completed by the consult manager 24. In an alternate embodiment, the patient 100 may self-register. Specifically, when patient self-registration is made available, the disclosed system and method 10 will allow a patient 100 to enter routine demographic information 12 and relevant medical history 14 him/herself. This information will then be confirmed at a later time by telephone or in person with the consult manager 24.

If, after competition of the consult report 72 from the consulting teledermatologist 66, the patient 100 desires notification of that the consult report 72 has been completed via e-mail, the patient 100 will be provided with a randomly generated password. The patient ID and the randomly generated password will allow the patient 100 access to his/her own completed consult report 72. Once the patient 100 has been notified 74 by an e-mail message that the consult report has been completed, the e-mail notification message 74 will allow the patient to click on a link within the e-mail message 74 to gain access to a log-on page. Once properly logged on, only the patient 100 will be able to view his/her completed consult report 72 together with the diagnosis, the treatment regimen, and follow-up plan.

Once the patient 100 has reviewed the information on the completed consult report 72, the patient 100 will be provided with a phone number to contact the requesting physician 22 with any questions and to schedule any needed follow-up. If immediate action by the patient 100 is required, instructions will be provided to the patient 100 on the immediate action to be taken.

Each patient 100 gaining access to the system 10 will be provided with the ability to easily search and view/edit only his/her own demographic information 12 and medical history 14. Further, each patient 100 will only be able to view the information contained in his/her own completed consult report 72, to include the consult history, images of the skin malady 52, and the recommendation from the consulting teledermatologist 66.

Each patient 100 gaining access to the system 10 will be able to select or modify the preferred method of being notified of the completion of the consult report via phone, e-mail, or regular mail, as described below. Automatic confirmation 82 that the completed consult report 72 has been received by the patient 100 may be added to the system 10. In the preferred embodiment, no diagnosis or treatment regimen is included on the original e-mail notification of completion of the consult report 72 sent to the patient.

Notification method selections available to the patient include:
E-mail—a link to the Website will be provided where the patient will be able to review diagnosis of the skin malady and the treatment regimen. In addition, links to additional publicly available information 76 related to their diagnosis or treatment plan information, such as available on www.webmd.com, will also be provided. Links may also be provided to restricted information. If the link is to restricted information, an ID/password may be provided.
Mail—a printed consult report, including the diagnosis of the skin malady, the treatment regimen, and follow-up information, will be provided along with any necessary contact information for asking questions or seeking more information.
Phone—an automated phone call message may be used to notify the patient that the consult report has been completed and is available. A phone number will be provided within the phone call message, should the patient have additional questions.
E-mail response or interactive phone response—automatic confirmation will be recorded in the system that the patient has been notified of the completion and availability of the consult report.

A sample menu of selections available to the patient on the patient screen appear in FIG. 5.
Consult—leads to selection of: View, Print (Link from diagnosis on view consult)
Patient—leads to selection of: View, Edit Profile
Admin—leads to selection of: Change Password, Contact Information
Miscellaneous—leads to selection of other options

b. Requesting Physician Screen

Registration Process: In the preferred embodiment, primary-care physicians 22 can be registered only by a site administrator 32. In an alternate embodiment, requesting physicians 22 may self-register. Once the registration of a self-registering physician 22 has been approved by the local site administrator 32, the referring physician 22 will become an authorized user of the system 10.

Level of Access: The primary-care physician 22 can create and add addendums to a request for a consult report 62 or a completed consult report 72, if necessary. To protect patient privacy, patient information can only be edited or viewed for those patients registered to the primary-care physician 22 who have records within the system. The primary-care physician 22 cannot gain access to a request for a consult report 62 or a completed consult report 72 of patients with whom they are not associated.

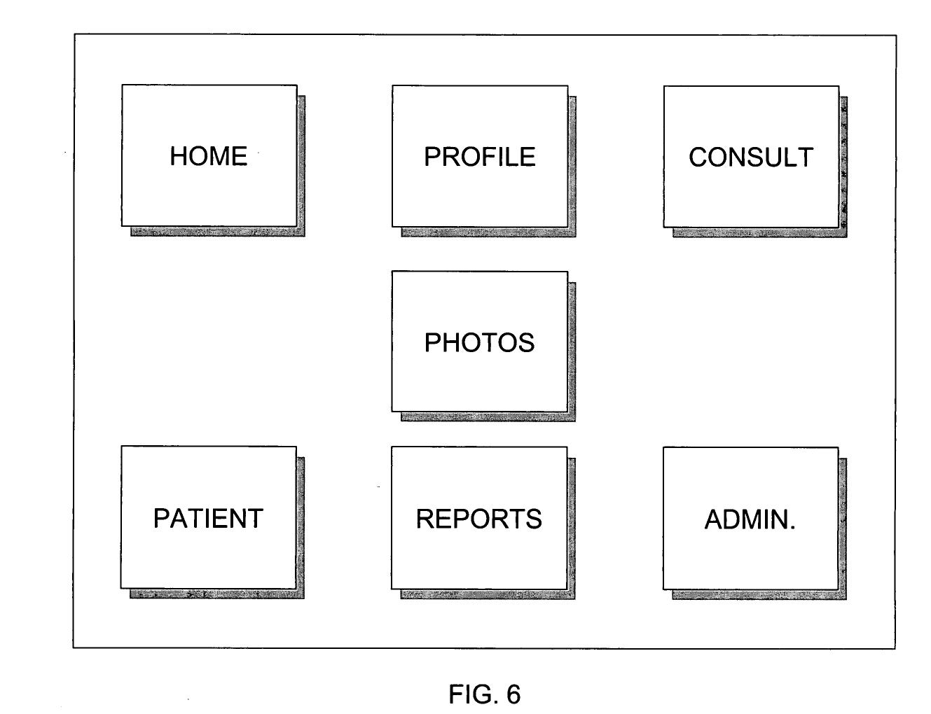

Profile: A sample of the selections available to a primary-care physician appear at FIG. 6. The menu of selections available to the primary-care physician or the requesting physician is as follows:
Homepage
Profile—leads to: Access to Physician's Information
Consult—leads to selection of: Create A Request For A Consult Report, Add
Addendum, View, Print, Add Digital Image
Photos—leads to selection: Images, Flag
Patient—leads to selection of: Add Patient, View/Edit Patient Information
Reports—leads to selection of: Alerts, Sites, Primary-Care Physician
Admin—leads to selection of: Change Password, View Satellite Site

The homepage selection is the default page that is loaded when a primary-care physician 22 logs on. Within the homepage, the physician 22 is able to see any active/pending requests for a consult report 62.

Using the reports button, the physician 22 is able to:
1) Review completed consult reports 62; specifically, the requesting physician 22 is able to review a list of request consult reports 62 that have been answered by the consulting teledermatologist 66 but not opened by the referring physician 22.
2) Review of list of patients to notify; specifically a list of requests for consult reports 62 that have been answered by the consulting teledermatologist 66 and opened by the requesting physician 22, will be provided. This list will include those consult reports where the “patient notify” button has not begin selected after the completed consult report 72 has been reviewed by the requesting physician 22.
3) Review of a list of pending request for consult reports; specifically, a list of requests for a consult report 62 that have not been answered by the consulting teledermatologist 66, will be provided. The entries on the pending list of requests for a consult report 62 provide an alert by changing their color to red if the time to receive a consult report has exceeded a preselected limit (default—72 hours).
4) Review a list of request for consult reports, specifically a list of requests for a consult report 62 that have been reviewed by the consulting teledermatologist 66, will be provided. The list will also include those requests for a consult report 62 where the consulting teledermatologist 66 has requested more information 75.

The requesting physician 22 can select and take various actions from a list organized under the foregoing headings.

a. Profile Selection

Selecting the Profile button allows the requesting physician 22 to view his/her profile. Changes to the profile of a requesting physician's profile are typically made by the local site administrator 32. Alternatively, the site administrator 32 may allow selected primary-care physicians 22 to modify certain parts of their own profiles. Information, such as state or special license information, may require an approval process. If used, the approval process may only be updated by the local site administrator 32.

b. Consult Selection

Selecting the consult button brings up specific menu items that relate to either a request for a consult report 62 or a completed consult report 72. The requesting physician 22 is able to create a request for a consult report 62, view a completed consult report 72, add an addendum to an existing consult report 72, print a request for a consult report 62, add digital photographic images, or flag a request for a consult report 62 or a completed consult report 72.

c. Patient Selection

Selecting the patient button allows for viewing or modifying the patient's demographic 56 and medical 54 information. Changes can be made by the primary-care physician 22 to any part of the patient information 56, 54.

d. Reports Selection

Selecting the reports button shows a list of requests for consult reports 62 or completed consult reports 72 that have met a predetermined “alert” status such as exceeding a pre-selected time period. A summary report of these items on “alert” status may be provided by the primary-care physician 22 and the site administrator 32.

e. Admin Selection

Selecting the admin button allows access user to the primary-care physician's ID and password along with any special satellite site information to which access has been granted.

f. Photos Selection

Selecting the photos button leads the requesting physician to the digital images 52 of the patient's skin malady.

Consulting Teledermatologist Screen

Registration Process: A consulting teledermatologist 66 can be registered as an authorized user of the system 10 by the system administrator 34. Once registered as an authorized user, the consulting teledermatologist 66 is then grouped into a designated organization. The system administrator 34 manages access to the system 10 by all authorized consulting teledermatologists 66 and oversees any additions to or deletions from this group.

Level of Access: A consulting teledermatologist 66 can view and answer any requests for a consult report 62 from either individual or groups of requesting physicians 22 that are located in a state where the consulting teledermatologist 66 is licensed to practice medicine. Alternatively, a consulting teledermatologist 66 will be able to view and answer requests for a consult report 62 if the consulting teledermatologist 66 has been assigned to a particular organization in addition to meeting the local license requirements.

The level of access to the disclosed system 10 provided to a consulting teledermatologist 66 is controlled by the registration process. Consulting teledermatologists 66 will only be able to see those requests for a patient consult report 62 or completed consult reports 72 from the states noted within their personal profile.

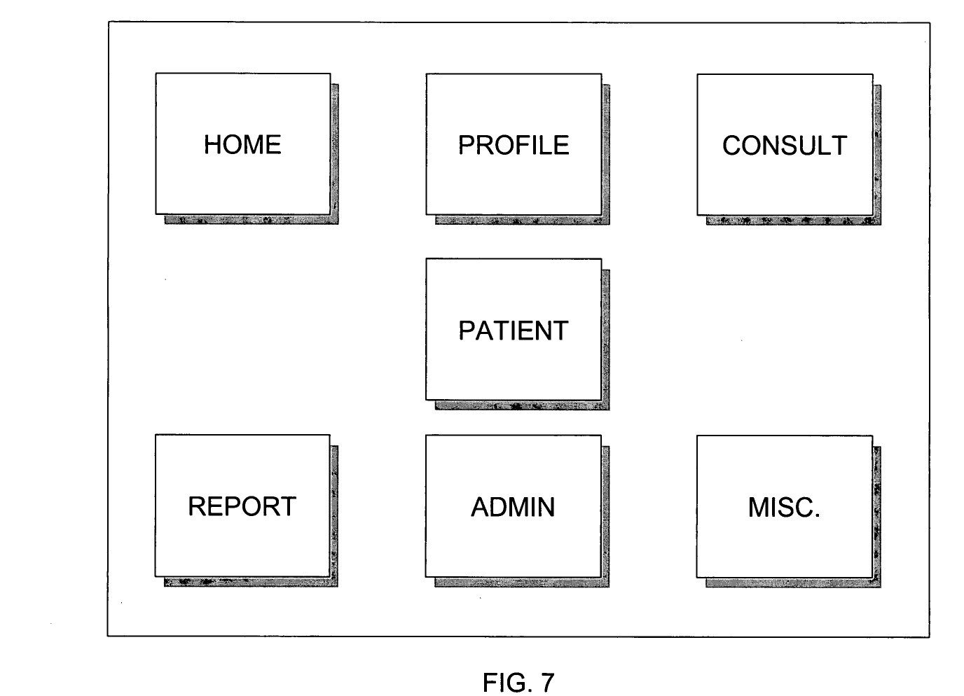

A sample screen provided to a consulting teledermatologist appears in FIG. 7.

The menu of selections available to a consulting teledermatologist follows:
Homepage
Profile
Consult—leads to a selection of: Answer A Request for a Consult Report, Create An Addendum To An Existing Consult Report, Flag A consult report, View, Print.
Patient—leads to a selection of: View, Patient
Reports—leads to a selection of: Alerts, Teledermatologist Activity
Admin—leads to a selection of: Change Password, View Satellite Site

The homepage is the default page that is loaded when the consulting teledermatologist 66 logs on to the system 10. Within the homepage, the consulting teledermatologist 66 is able to see any pending requests for a consult report 62 or any completed consult reports 72.

The consulting teledermatologist may also view:
1) Resubmitted requests for a consult report 62.
2) Answered requests for a consult report 62 that have been resubmitted by the requesting physician 22 or resubmitted with additional images or information from the requesting physician.
3) Answers to new requests for a consult report.
4) Requests for a consult report 62 that have not been opened by the consulting teledermatologist 66.
5) Pending requests for a consult report that have been opened/viewed by the consulting teledermatologist 66 but have not yet been answered.

Once a request for a consult report 62 has been opened, that request 62 cannot be answered by another consulting teledermatologist 66 for a predetermined number of hours. After the passage of a predetermined number of hours, the request for a consult report 62 can be answered by any approved consulting teledermatologist.

Selecting the profile button allows the consulting teledermatologist 66 to view his/her own profile. Changes to the profile of a consulting teledermatologist 66 may be made by the local site administrator 32. Alternatively, the consulting teledermatologist 66 will be able to modify certain parts of his/her own profile. Information such as state medical license information must first pass through an approval process by the organization using the disclosed system. Accordingly state medical license information may only be updated by the local site administrator 32.

Selecting the consult button brings up the menu items that relate to completed consult reports. A consulting teledermatologist 66 can view a completed consult report 72, add an addendum to a completed report 72, print, or flag a completed consult report 72.

Selecting the patient button allows the consulting teledermatologist 66 to view the patient's demographic 56 and medical 54 information. Changes cannot be made to the patient's information 56, 54 by the consulting teledermatologist 66.

Selecting the reports button shows a list of requests for a consult report 62 or completed consult reports 72 that have met the “alert” status, such as those meeting a pre-selected time criteria. A summary report of requests for consult reports 62 answered by the consulting teledermatologist 66 may also be provided.

Selecting the admin button allows the consulting teledermatologist 66 to change his/her own password and view selected satellite site information for which access has been granted.

Selecting the photos button allows the consulting teledermatologists 66 to view all the individual digital photographic images 52 beginning with thumbnail views. These thumbnail views can be enlarged and manipulated or enhanced using an included image viewer (contrast, brightness, rotate, etc.) accessed in a separate browser window. The consulting teledermatologist 66 will be able to view all of the patient- and complaint-based information in the original application browser window.

Once having reviewed the information supplied, the consulting teledermatologist 66 will generally be able to render a diagnosis, prepare a recommended treatment regimen, and describe a follow-up plan. The diagnosis, treatment regimen, and follow-up plan are entered using templates unique to the screens provided to the consulting teledermatologist 66. The level of diagnostic agreement with the requesting physician 22 may also be included in the completed consult report 72.

Alternatively, the consulting teledermatologist 66 will be able to quickly create a tailored template of skin maladies frequently encountered or related to a particular geographic area. Such tailored template will enable the consulting teledermatologist 66 to click on a predetermined diagnosis. Selection of the predetermined diagnosis will give the consulting teledermatologist 66 the option of accepting a default treatment regimen, a default follow-up schedule, and/or other default recommendations or instructions specific to the patient's complaint.

Alternatively, each consulting teledermatologist 66 will be able to perform chart reviews on randomly selected patients to assure that quality diagnoses, treatment regimens, and follow-up plans are being provided in a timely manner.

d. Consult Manager Screen

Registration Process: Individual consult managers 24 can only be made authorized users of the system by the site administrator 32. In metropolitan areas, it is expected that multiple consult managers 24 will be registered at a single site. It is also possible to designate primary and multiple secondary consult managers within a single consult manager registration. The designation of primary and secondary consult managers permits automatic data population within the follow-up section. Also, in some applications, it may be necessary to designate a super consult manager with access rights to multiple sites at multiple locations.

Level of Access: The consult manager 24 can create and view requests for a consult report 62 and view/edit patient information 12, 14 on patients 100 who are registered at the physical location of a requesting physician 22. In certain special circumstances, a super consult manager will be given access to multiple designated physical locations.

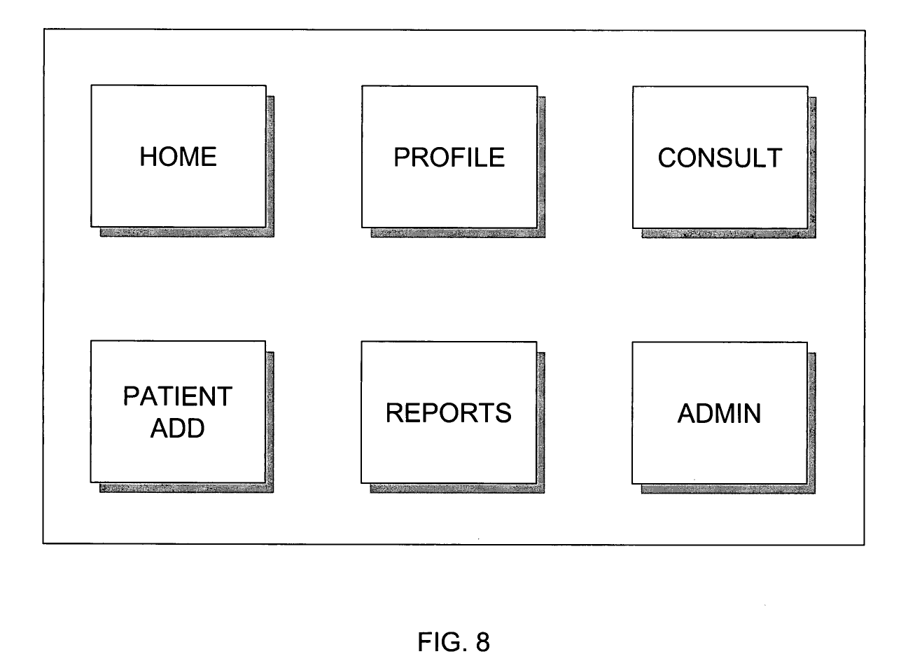

A sample screen presented to a consult manager profile appears in FIG. 8.

The menu of selections available to the consult manager follows:
Homepage
Profile
Consult—leads to a selection of: Create Consult, Add Addendum, View, Print, Add Images, Flag
Patient—leads to a selection of: Add Patient, View/Edit Patient
Reports—leads to a selection of: Alerts, Sites, Primary-Care Provider
Admin—leads to a selection of: Change Password, View Satellite Site

The homepage is the default page that is loaded when the consult manager 24 logs on to the system. Within the homepage, the consult manager 24 is able to see any requests for a consult report 62 originating from his/her physical location. Specifically, the consult manager 24 will be able to see:
1) Requests for a consult report requiring images
   Any requests for a consult report 62 that have been submitted without digital photographic images 52 will be identified. After digital photographic images 52 have been attached to a request for a consult report 62, the consult manager 24 will be able to submit the request for a consult report 62 to a consulting teledermatologist 66.
2) Pending requests for a consult report
   Requests for a consult report 62 that have been submitted to a consulting teledermatologist 62, but have not yet been answered, are displayed. The pending request for a consult report 62 provides an alert by changing to the color red if no completed consult report 72 has been received within a predetermined time.
3) Patients to notify
   Requests for a consult report 62 that have been answered by the consulting teledermatologist 66 and opened by a requesting physician 22 without the “patient notify” button being selected after reviewing the results are displayed.
4) Requests for a consult report 62 requiring additional information
   Consult report requests 62 that have been reviewed by a consulting teledermatologist 66, where additional information 75 has been requested, are displayed.
5) Review completed consult reports
   Requests for a consult report 62 which have been answered by a consulting teledermatologist 66 with a completed consult report 72, but where the completed consult report 72 has not been opened by the requesting physician 22, are displayed.

The consult manager 24 can select and then take action appropriate to the status of a request for a consult report 62 from the list of requests for a consult report 62 organized under the above headings.

Selection of the profile button allows the viewing of the consult manager's own profile. Any changes to the consult manager's profile are made by the local site administrator 32. Under certain circumstances, the consult manager 24 will be able to modify only predetermined parts of his/her own profile. Information such as a change in consult manager type and location information must pass through an approval process. Such changes to type and location information may only be made by the local site administrator 32.

Selection of the consult button produces a menu of items that relate to requests for a consult report 62. The consult manager 24 is able to create a request for a consult report 62, view a request for a consult report 62, view a completed consult report 72, add an addendum to a completed consult report 72, print, add more digital photographic images, flag a completed consult report 72, or flag a request for a consult report 62.

Selection of the patient button selection allows the viewing or addition of the patient's demographic 56 and medical 54 information. Changes can be made by the consult manager 24 to any part of the patient information.

Selection of the reports button shows a list of requests for a consult report 62, completed consult reports 72 that have met an “alert” criteria. A summary report of requests for a consult report 62 or completed consult reports 72 sorted by primary-care physicians 22 and locations can also be provided.

Selection of the admin button allows the consult manager 24 to change his/her own password and view location information.

e. Site Administrators Screen

Registration Process: Only the system administrator 34 can register a site administrator 32. There is only one site administrator 32 per organization of physicians 22 and consult managers 24.

Level of Access: The site administrator 32 will be able to view all patient information 12, 14 and requests for a consult report 62 and completed consult reports 72. The site administrator 32 will not be able to add or edit patient information 12, 14 requests for a consult report 62 or a completed consult report 72.

Profile: The site administrator 32 does not have access to his/her own profile information. This site administrator's profile information is created and maintained by the system administrator 34.

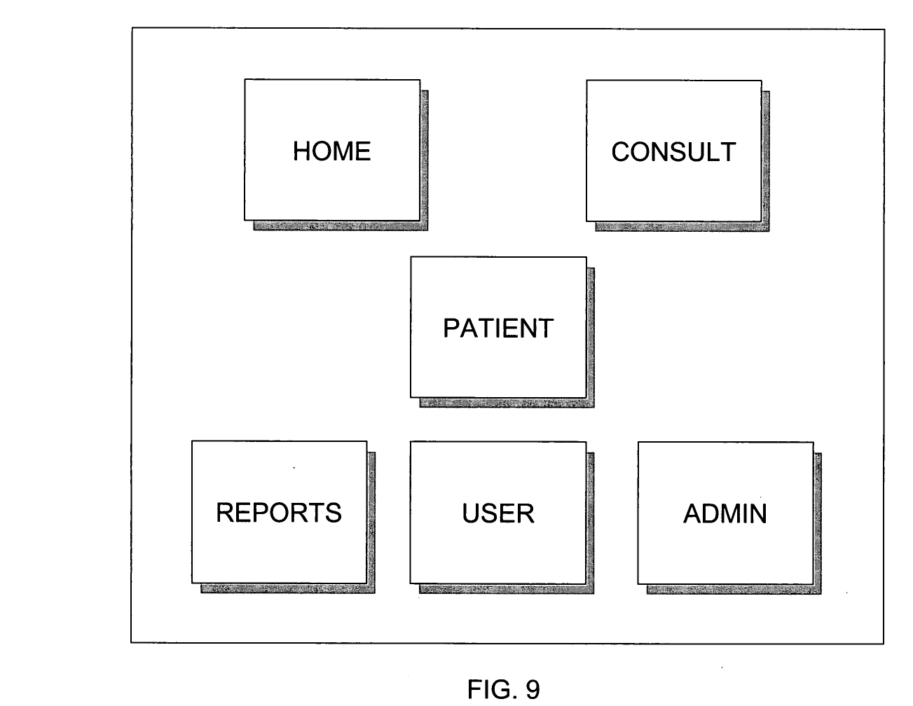

A sample menu of selections available to the site administrator appears in FIG. 9:
Homepage
Consult—leads to a selection of: View, Print, Remove
Patient—leads to a selection of: View/Edit, Delete Patient
Reports—leads to a selection of: Alerts, Sites, Requesting Physicians, Consulting Teledermatologists
Admin—leads to a selection of: Change Password, View/Edit Org, View/Edit Satellite Site, Add Satellite sites, Audit
User—leads to a selection of: Reset Password, Unlock Acct., Add/Edit user, Delete

The homepage selection is the default page that is loaded when a user logs on to the system.

1) Within the homepage, the site administrator 32 should able to see any patients 100 who have not been notified of the completion of a consult report 72 and any alerts.

2) Patients to notify
Requests for a consult report 62 that have been answered by a consulting teledermatologist 66 and opened by a requesting physician 22, where the “patient notify” button has not been selected after reviewing the results, are displayed.

3) Alerts
A listing of those requests for a consult report 62 which have exceeded a certain criteria such as the time requirement for notification or action are displayed.

The site administrator 32 can select and take action appropriate to the status of a request for a consult report 62 from the list of requests for a consult report 62 organized under one or more predetermined headings.

The other selections available to the site administrator appear in FIG. 9.

Selection of the consult button produces a menu of items that relate to requests for a consult report 62. The site administrator 32 is able to view a request for consult report 62, delete a request for a consult report 62, and print a request for a consult report 62.

Selection of the patient button allows the viewing and editing of the patient's demographic 56 and medical 54 information. Patient records can also be deleted or hidden by the site administrator 32.

Selection of the reports button shows a list of requests for a consult report 62 that have met an “alert” status criteria. Also shown is a summary report of requests for a consult report 62 by primary-care physicians 22, by physical location, and by consulting teledermatologists 66.

Selection of admin button allows the site administrator 32 to change his/her password. In addition, the site administrator 32 can view/edit the organization, view/edit the list of physical locations, and audit requests for a consult report 62.

Selection of the user button allows the site administrator 32 to reset passwords, unlock accounts, add/edit users, and delete or hide users.

f. Other User Screens

Super Technician: This screen is the same as the consult manager screen shown in FIG. 8 but also provides access to requests for a consult report 62 for patients from other designated physical locations.

Associated Dermatologist: This screen (not shown) only permits a dermatologist assisting a consulting teledermatologist to view designated referred requests for a consult report and patient information.

Front Desk Person: This screen (not shown) only permits a receptionist to display a list of patient appointments. Only a limited view and edit rights for patient information is provided.

Credentialing Officer: This screen permits edits and approves changes in state medical licenses, changes in privileges, and authorizations to perform certain procedures (e.g., shave biopsy).

Application Logic/Rules Modules

A still better understanding of the disclosed system and method 10 may be had by a review of the Application Logic/Rules Modules 4 shown in FIG. 4.

a. Homepage Module

Requests for a consult report 62 and completed consult reports 72 with a specified status will be listed and organized and under different categories in various homepages described above. The categories of requests for a consult report 62 and completed consult reports 72 listed on the various homepages will vary based on the user type. The categories of requests for a consult report 62 and completed consult reports 72 are based on the status of requests for a consult report 62 or completed consult reports 72. The status of the request for a consult report 62 or a completed consult report 72 will change as various actions (creation, adding addendum, answering requests for a consult report, opening a request for a consult report, notifying patients, etc.) are taken on a given request for a consult report 62.

b. Consult Module

Certain information fields, typically marked by an asterisk (*), are mandatory and must be filled out. If a mandatory information field is not filled out, a reminder is provided and the specified action cannot be completed until an appropriate entry is made in the information field.

Consulting teledermatologists' recommendations (diagnosis, treatment, follow-up) are linked to each complaint received conveyed by the requesting physician 22.

If a request for a consult report 62 is submitted without digital photographic images 52 of the skin malady, the request for a consult report 62 cannot be seen by the consulting teledermatologist 66. Once the digital photographic images 52 of the skin malady are added to the request for a consult report request 62, the request for a consult report 62 then becomes available to be answered.

Status tracking allows tracking of requests for a consult report 62 in various stages to allow alert notification if the requirements are not met (e.g., 48 hours for PCM review, 72 hours for consulting teledermatologist review, 7 days for patient notification).

1) Consult Status Stages Tracked in the Consult Module

Pending Inclusion of Digital Photographic Images 52 (status once a request for a consult report 62 is submitted but is without images).

Submitted (a request for a consult report 62 with digital photographic images 52 has been submitted to a consulting teledermatologist 66).

Resubmitted (request for a consult report 62 has been resubmitted with additional digital photographic images 52 or information).

A Request for a Consult Report Received (a request for a consult report 62 has been received by a consulting teledermatologist 66, but no diagnosis or treatment regimen has been added).

Request for A Consult Report Forwarded (a request for a consult report 62 has been reviewed and has been forwarded to an associated dermatologist for a recommendation, a diagnosis, a treatment regimen, or a follow-up plan).

Completed Consult Report—not opened (a request for a consult report 62 has been reviewed, recommendations have been made, but the requesting physician 22 has not reviewed the completed consult report 72).

Completed Consult Report—opened.

Patient notified of completed consult report.

Additional Information Pending To Complete Consult Report.

Digital Photographic Images Needed (This request for a consult report requires additional digital photographic images 52 and will be tagged as such. The request for a consult report 62 remains in this status until additional digital photographic images 52 are resubmitted. If the requests for a consult report 62 are not resubmitted with the needed digital photographic images 52 or the needed information after 7 days, a reminder e-mail is sent to the consult manager 24. After 14 days, a reminder e-mail is sent to the site administrator 32).

2) Notification of Completed Consult Report

When the request for consult report 62 is answered by a consulting teledermatologist 66, an e-mail is automatically generated and sent to the requesting physician 22 who created the request for a consult report 62 and to the consult manager 24 with a link to the log-on page. This link to the log-on page allows a browser to open the completed consult report 72 with capability to remember the ID/password from that PC. Once logged on, the user will see all new completed consult reports 72 in the homepage.

Requesting physicians 22 may have the option of sending the patient notification of their review of a completed consult report 72 via e-mail (the patient must grant permission for this). The e-mail will include a link to the patient's completed consult report 72. The patient will log on using an ID and password provided at the time of registration.

If the patient has selected “no e-mail notification,” the requesting physician 22 will select the “patient notified” button within the “view consult report” page after calling the patient 100. Those completed consult reports 72 where the patient has not been notified will remain in the “patients to be notified” category in the homepage.

Patient Module

Only the consult manager 24 or the primary-care physician 22 at predetermined locations can add patients to the database. Alternatively some patients will be allowed to register themselves, but such self-registration must be approved by a consult manager 24 or a requesting physician 22 prior to the creation of a request for a consult report 62. The patient module includes a demographic information 12 and a medical information section 14 and can be edited by the appropriate users. In certain limited circumstances, patients will have the ability to self-edit their own demographic 12 and medical 14 information.

Reports Module

The reports provided are broken down into three sections:
reports for a requesting physician 22,
reports for a consulting teledermatologist 66, and
reports for the site administrator 32.

The reports module contains a summary of the requests for consult report 62 data that may be used for a diagnostic correlation between the consulting teledermatologist 66 and the requesting physician 22. The report module also contains volume/frequency statistics. A volume/frequency report is based on the user type. If a report is requested by a requesting physician 22, a report may be obtained based on the requests for a consult report 62. If a report is requested by a consult manager 24, a report may be obtained based on all requests for a consult report 62 generated from that location and by each requesting physician 22. If a report is requested by a consulting teledermatologist 66, a report may be obtained based on all the requests for a consult report 62 which have been answered. If a report is requested by a site administrator 24, a full report may be obtained by all or each primary-care physician 22, each consulting teledermatologist 66, and each site. The following list sets forth other report options.
Reports (volume, frequency).
By Dates (with a specified date range)
By Provider
By sub-sites
By disposition
By diagnosis
By patients
By follow-up status.

In addition, customizable queries will be enabled by the report module.

User Module

Registration will be performed by the site administrator 22. Approval of consulting teledermatologists 66, consult managers 24, and site administrators 32 may only be done only by the main system administrator 34.

Each user has a unique set of self-selected password and ID specific only to the associated site. For example, UserID-firstname.lastname

Admin Module

The system administrator 34 will have full privileges except the ability to view the source code. Only the system administrator 34 can create a new organization and a new site administrator 32.

The site administrator 32 will enter all locations and their users. The site administrators 32 have access to all patients and all requests for a consult report 62 created from their organization. However, the site administrators 32 will not be able to create or make addendums to requests for a consult report 62 or completed consult reports 72. Site administrators 32 can edit patient information 12, 14.

Password Module

When a new user is created, a default password may be provided. When the user logs on to the system for the first time, the user is forced to change the default password to one of his/her own choosing. The site administrator 32 who registers each user sets the user ID. Once the user is created, his/her user ID cannot be used even after users are deleted/deactivated.

Search Module

The search module works in the same way as other search tools. The built-in limitation is that users with only local privileges (consult managers 24, requesting physicians 22) can only search and view requests for a consult report 62 and completed consult reports 72 from their own physical location. The site administrator 32 will be able to search requests for a consult report 62 from any or all of the designated locations within a site. A consulting teledermatologist 66 can search and view requests for a consult report 62 only from those sites that match his/her state license.

Requests for a consult report 62 or completed consult reports 72 can be searched by using:
by Patient name
by Patient SSN
by Dates
by Consult ID
by Referring physician's (PCP's) name
by Referring site
   Image Module

In the preferred embodiment, JPEG images are uploaded. If an attempt is made to upload any other type of digital photographic image, the user will receive an error message, and the request for a consult report 62 cannot be submitted. Multiple digital photographic images 52 can be submitted per patient complaint, and multiple patient complaints can be submitted in one request for a consult report 62.

Site/Satellite Module

Main organizations are created by the system administrator 34. Once an ID and password for each site administrator 32 is set, the site administrator 32 can then create an unlimited number of new locations along with users associated with the location (requesting physicians 22, consult managers 24). A group of consulting teledermatologists 66 may be managed by a system administrator 32 under a separate organizational site.

Print Module

The print module allows for the selection of printing of the information associated with a request for a consult report 62. This information is separated into a consult referral section and a consultant section. The data that is populated into the print module comes from the various sections of the request for a consult report 62 and includes the patient information 12, 14, the information concerning the request for a consult report 62, and information on completed consult reports 72.

Other System Capabilities.

For greater usability, the disclosed system may be linked to other software related to insurance claims, occupational health reporting systems, billing systems, prescription systems, medical information systems, patient data storage systems, etc.

Because of the flexibility and adaptability of the present system, it offers certain special features, including:

Customizable consulting teledermatologist recommendations:
A template module is included for describing either common or special conditions that can be customized based on a particular diagnosis.
A template module is included for testsibiopsies/procedures available to a consulting teledermatologist based on the location of registered sites and requesting physicians.

When a new site or a new primary-care physician is added, certain characteristic features will be noted in the database—which will then allow customization of recommendations typically provided by consulting teledermatologists to facilitate communication with requesting physicians.

Reports are customizable to allow data mining.

Follow-up procedures and notification methodology are customizable by user type and organization (main/satellite).

Resident dermatologists can be included as users, subject to review and approval.

Surrogates for a consulting teledermatologist and requesting physicians can be included.

The body map can be customized to illustrate location of a dermatological disorder with greater precision of location.

Users can be given greater access to their profiles, while approval of certain critical fields is retained by the site administrator.

A separate consulting teledermatology organization may be created to allow maintenance by a designated credentialing organization.

Creation of appointment templates by location and by time can be created for patients. If the patient needs a follow-up appointment, a designated scheduler will be able to see a list of the patient's name and phone number to contact the patient and book the appointment. Alternatively, most commonly used scheduling system can be used to allow booking of follow-up patients. For a dermatology follow-up, a customized list of available dermatologists who will be notified electronically (via e-mail) or via fax is provided.

Drop-down lists may be used when adding patient information or creating requests for a consult report. The view screens can be used to select how the data is displayed when many items are selected. For example: the following fields are adaptable for multi-select:
Create Consult (Primary-Care Physician and Consult Manager Memo)
   Main Symptoms
   Ameliorating factors
   Exacerbating factors
Profile
   Type of procedures

In the review of symptoms list and in the medical history, certain specific findings will be noted in red letters (for example: Allergies should be in red if other than the default “NKDA”).

Interface links to Internet medical research tools can be provided for the requesting physician.

Comments can be captured and delivered to the requesting physician/consult manager/teledermatologist along with the requests for a consult report.

Data fields format such as phone numbers to be (XXX) XXX-XXXX can be customized to allow more accurate data entry and easier viewing.

Patients can be provided e-mail access to the system. Notifications to the patients will be governed by the rules which govern access to that patient when the diagnosis requires requesting physician be involved.

A QI section can be added to allow selection of consulting teledermatologists to perform chart/record review based on a predetermined percentage of randomly selected cases and to send reminders.

The site administrators can be allowed to set the percentage of requests for a consult report and the frequency of chart review. Based on this set percent and frequency, a designated consulting teledermatologist will review randomly selected cases (selected by system) along with their diagnosis, treatment regimen, and follow-up plan.

A scheduling module can be set up for consulting teledermatologists.
Teledermatologists can be allowed to sign up for a designated work schedule or block their availability, as needed.

Consult managers can be notified via e-mail whenever one or more of the following events occurs:
A submitted request for a consult report request has not been answered within 72 hours.
A patient has not been notified within 10 days of the request for consult report submission.
When a request form consult report from his/her site is answered by the teledermatologist.

If a patient needs a follow-up appointment, a designated scheduler will be able to see a list of the name and phone numbers of the patient to contact to book the follow-up appointment. Alternatively, a commonly used scheduling program can be used to book follow-up appointments. A print-out of a list of patients requiring a follow-up appointment can be sorted by time to follow up and by type of follow-ups (PCM, Derm, Other Specialty). For Dermatology and Other Specialty follow-ups, a batch print of individual requests for a consult report can be submitted. A request for a consult report may be sent electronically to other systems.

In an alternate embodiment, a subsystem can be added that automatically enters, or allows the consult manager or the requesting physician to enter, results of a procedure or test when a procedure or test has been recommended. The consulting teledermatologist has the option to keep a running list of requests for a consult report that have pending tests/procedures.

Old cases can be compared to new cases with side-by-side imagery.

Status Tracking reminders can be provided, as follows:
a Automatic reminders via pager, e-mail, fax, etc., or on an updated phone list can be provided at designated time intervals to requesting physicians or consulting teledermatologists.
Consult managers can be reminded of those patients who have not confirmed receipt of a completed consult report.
A phone number list or e-mail address list can be generated for patients who have not confirmed receipt of a completed consult report.
A list with phone numbers or e-mails for patients who have not confirmed receipt of a completed consult report can be generated.

Contact information for authorized users is available via link by any user. For example, the name of a consult manager and a requesting physician is available. Selection of that link shows a profile with all necessary contact information

A surveillance system may be put in place where a pager notification occurs if a dermatological disorder raises concern for biological or chemical exposure.

An image database is provided that allows requesting physicians to view textbook images of skin conditions based on the diagnosis listed.

A customizable fax notification is provided to a requesting physician as part of user registration.

Old completed consult reports can be provided for designated time periods.

Off-line access can be made available.

Demographic and medical data from multiple distinct fields may be converted into text entries. The text entries can be presented in paragraph format that allows the consulting teledermatologist to rapidly read/review the patient information without having to review extraneous data.

Status tracking capability can be modified to adapt for changes. For example, the request for a consult report status changes based on a number of actions, including:
Generation of request for a consult report
Attachment of images to the request for a consult report
Opening of a request for consult report by a consulting teledermatologist
Opening of a completed consult report by a requesting physician
Submission of recommendations by a consulting teledermatologist
Requesting physician opens the completed consult report
Patient opens the completed consult report
Addendums are submitted to the completed consult report
A link is made to a diagnosis

Referring physicians will be able to click on the diagnosis when viewing recommendations from a completed consult report. A search may then be performed within an outside reference site (such as an e-medicine site) for further research/education.

Patients will be able to click on the diagnosis when viewing recommendations from the consulting teledermatologist and will be able to perform a search within a public Website (e.g., patient AAD site) for additional information.

Differential Diagnosis Link
When the consulting teledermatologist selects a diagnosis, a list of differential diagnosis options will be automatically generated along with the linked images to provide the option to a consultant teledermatologist of a review of related diagnosis options.
When a requesting physician selects a diagnosis, a list of related diagnostic options will be automatically generated along with thumbnail images illustrating the related diagnostic options and providing clinical information. The requesting physician will then have the option of not sending the request for a consult report or continue adding images to the request for a consult report.

Template
Consulting teledermatologists will have the option of selecting from a pre-formed template of common diagnoses such as “Actinic Keratosis, Urticaria, etc.” When an optional diagnosis is selected, the diagnosis and a brief description of the skin malady, along with the most common management options for that diagnosis, can be selected. The selection provides the ability to edit any part of a treatment recommendation.
Consulting teledermatologists will be able to customize responses for common dermatologic conditions for future use.

Quality Assurance

This option allows a predetermined percentage of charts/consult reports to be randomly selected for review. Once this predetermined percentage is set along with a time period, the completed consult reports can be reviewed without revealing the patient's or the consulting teledermatologist's name. A set number of predetermined questions will be asked to ensure reliability and validity.

An additional feature will be provided to track the type of cases and percentage of diagnostic correlation between consulting teledermatologists and the requesting physicians to allow opportunity for education and feedback for those requesting physicians that fall below a predetermined diagnostic correlation percentage.

Case of the Week/CME

An option will be provided to allow the consulting teledermatologist to bookmark/select any case to be archived for future teaching purposes. This action then reformats the data so that CME questions can be generated while a large archival library can be built.

Image Upload
A setup option will allow selection of the default removable drive where the digital images are located.
The browser will automatically load the images on the default drive as thumbnail images.
Certain patient information from the demographics will be automatically tagged to the images. An option will allow additional data entry such as location.
Prior to submission, the images can be selected for rotation, uploading, or deletion.

Integration of Consults with EPR
The patient's demographic and general clinical information such as patient's medical history, patient's treatment history, etc., are updated from the completed consult reports.
Each patient's consults can be viewed by selecting it from a chronologically sorted list.

Decision Support Integration
The system will integrate decision software such as the Expertiser™ from MoleMax II or others to assist the teledermatologist in improving the reliability and validity of diagnosing a single pigmented lesion and other skin conditions.
Image viewer—DICOM format support. Markup and annotation along with slide presentation mode to allow automatic loading and browsing.

Medical students in residence will be able to respond to requests for consult reports, but such responses will not be submitted until a staff member reviews it and approves or edits it.

A telederm photography algorithm may be built into the application.

A consult template may be built for patients (self-referral).

The insurance information section may be enhanced to allow future integration.

Known uses for the disclosed system and method include:
US and international healthcare market
VA and military
Prison systems
Nursing homes
Electronic patient records
CME
Image library
Biological or chemical skin exposure surveillance
Medical Expert Systems

The primary user community is expected to be that of the requesting physician. However, the disclosed system and method is also designed with both the consulting teledermatologist and the patient in mind. It is assumed that the user of the disclosed system will be generally inexperienced with communication over the Internet and have only basic browser familiarity.

While the disclosed system has been described according to its preferred and alternative embodiments, those of ordinary skill in the art will understand that numerous other embodiments have been enabled by the foregoing disclosure. Such other embodiments shall be included within the scope and meaning of the appended claims.

1. A system for requesting and then providing a report by a consulting physician on a diagnosis and treatment plan for a patient complaint, said system comprising:
a module for recording patient demographic and medical information;
a module for recording visual images illustrating the symptoms of a patient;
a module for preparing a request for the report by a consulting physician;
a module for preparing the consulting physician report;
a subsystem for tracking the status of the request for a report by a consulting physician; and
a subsystem for providing access to both the request for and the completed report from the consulting physician.

2. The system as defined in claim 1 wherein said subsystem for tracking the status of a request for a report from a consulting physician records one or more of the following events:
a) the existence of a need to add said visual images to the request for a report by a consulting physician;
b) the transmission of the request for a report to a consulting physician;
c) the receipt of the request for a report by the consulting physician;
d) the review of the request for a report by a consulting physician;
e) the need for additional information by the consulting physician; and
f) the resubmission of the request for a report to a consulting physician.

3. The system as defined in claim 1 wherein said subsystem for tracking the status of a request for a report from a consulting physician records one or more of the following events:
a) the submission of a request for additional information by the consulting physician;
b) the completion of the report by the consulting physician;
c) the transmission of the report by the consulting physician;
d) the review of the report transmitted by the consulting physician.

4. The system as defined in claim 1 wherein said subsystem for providing access to both the request for and the completed report from a consulting physician provides notice of one or more of the following events:
a) transmission of the request for the report from the consulting physician;
b) the receipt of the request for the report from the consulting physician;
c) the completion of the report by the consulting physician;
d) the receipt of the completed report by one or more of the following: the requestor, the patient, and an administrator responsible for the system operation;
e) the review of the completed report by one or more of the following: the requestor and the patient.

5. The system as defined in claim 4 wherein said notice to the requestor or to the patient provides a link providing access to the completed report.

6. The system as defined in claim 5 wherein said access to the completed report provides a link to information explaining entries in the completed report.

7. The system as defined in claim 5 wherein said access to the completed report can establish a schedule of follow-up patient appointments.

8. A method for providing a diagnosis, treatment regimen, and follow-up plan for a dermatological disorder from a requesting primary-care physician in physical contact with the patient to a consulting dermatologist using Internet communication, said method comprising the steps of:
a) completing an electronic record of patient demographic information;
b) completing an electronic record of patient medical information;
c) completing an electronic record of pictures of the dermatological disorder;
d) transmitting selected items of said demographic information; selected items of said medical information; and selected pictures to a dermatologist in the form of a request for a consult report from the primary-care physician;
e) transmitting one or more of a diagnosis, a treatment regimen, and a follow-up plan from said dermatologist to the primary-care physician in the form of a completed consult report;
f) tracking the foregoing steps;
g) reporting on the completion of one or more of the following: transmission of said request for consult; review of said request for consult; transmission of said completed consult report; and review of completed consult report.

9. The method as defined in claim 8 further including the step of reducing said patient demographic and patient medical information into a succinct format easily readable by the consulting dermatologist.

10. The method as defined in claim 8 further including the step of adding a body map specifying the location of the dermatological disorder.

11. The method as defined in claim 8 further including the step of providing for the submission of a request for additional information by the consulting dermatologist to the requesting primary-care physician.

12. The method as defined in claim 8 further including the step of providing for the addition of additional information to the completed consult report by the requesting primary-care physician.

13. The method as defined in claim 8 wherein those performing the steps or receiving information from the performance of the steps can only perform the steps or receive information from the performance of the steps after approval by an administrator.

14. The method as defined in claim 8 wherein the primary-care physician only has access to records related to patients personally referred to the consulting dermatologist.

15. The method as defined in claim 8 wherein the consulting dermatologist only has access to records related to patients on which a request from a primary-care physician has been received.

16. The method as defined in claim 8 wherein the consulting dermatologist is prohibited from receiving records from locations where the consulting dermatologist is not licensed to practice medicine.

17. The method as defined in claim 8 wherein the requesting primary-care physician can include a preliminary diagnosis in said request for a consult report.

18. The method as defined in claim 8 wherein the requesting primary-care physician is provided a link to information on dermatological disorders to assist in the preparation of said request for a consult report.

19. The method as defined in claim 13 wherein those receiving approval by an administrator can only perform the steps or receive information from the performance of the steps through proper access using an identification and password.

20. The method as defined in claim 13 wherein the administrator cannot modify any patient record, said request for a consult report, or said completed consult report.

21. The method as defined in claim 8 wherein selected requests for a consult report or selected completed consult reports can be flagged.

22. The method as defined in claim 8 wherein a report can be provided when the time between the performance of said steps exceeds a predetermined time limit.

23. A network of computer terminals and server computers enabling Internet communication of information received from a patient, a request for assistance in determining a diagnosis, a treatment regimen, and a follow-up plan for a malady, and a response to said request for assistance, said network comprising:
a computer terminal on which a screen is provided for inputting patient demographic and medical information to a database;
a computer terminal on which a screen is provided for inputting an image of visually observed patient symptoms to a database;
a computer terminal on which a screen is provided for preparing the request for assistance by drawing information from said database;
a server computer for transmitting the request for assistance to a computer terminal on which a screen is provided for receiving the request for assistance;
a computer terminal on which a screen is provided for preparing the response to the request for assistance;
a server computer for transmitting the response to the request for assistance;
a computer terminal on which a screen is provided for receiving the response to the request for assistance;
a server computer for tracking the completion of the request for assistance, the transmission of the request for assistance, the completion of the response to the request for assistance, and the transmission of the response to the request for assistance;
a server computer for providing notice of the transmission of the request for assistance, notice of the receipt of the request for assistance, notice of the transmission of the response to the request for assistance, and notice of receipt of the request for assistance.
